(19) United States
(12) Patent Application Publication
(10) Pub. No.: US 2014/0087577 A1
(43) Pub. Date: Mar. 27, 2014

(54) PLUGGABLE SYSTEM AND OPTICAL TRANSCEIVER APPLICABLE TO PLUGGABLE SYSTEM

(71) Applicant: Kazushige Oki, Yokohama-shi (JP)

(72) Inventor: Kazushige Oki, Yokohama-shi (JP)

(73) Assignee: Sumitomo Electric Industries, Ltd., Osaka-shi (JP)

(21) Appl. No.: 14/116,310

(22) PCT Filed: May 9, 2012
(86) PCT No.: PCT/JP2012/062564

§ 371 Date: Nov. 7, 2013

(30) Foreign Application Priority Data
May 11, 2011 (JP) 2011-106479

(51) Int. Cl. H01R 13/52; H01R 13/658

(52) U.S. Cl. CPC H01R 13/5219; H01R 13/658
USPC 439/271

(57) ABSTRACT

An optical transceiver and a pluggable system to enhance the reliability of the communication between the optical transceiver and the host system are disclosed. The rear of the housing of the transceiver provides a periodic structure, a plurality of hollows or a plurality of projections, arranged along the gasket provided in the host connector. Only portions of the periodic structure come in contact with the gasket, and the repulsive force caused by the gasket is consequently weakened to enhance the reliability of the mating of the plug in the optical transceiver with the host connector. The width of the hollows, or the pitch of the projections is set to be shorter than a quarter wavelength of a signal transmitted between the transceiver and the host system to reduce the EMI radiation leaking from the end of the transceiver.

### TECHNICAL FIELD

Embodiments of the present invention relates to a pluggable system for an optical transceiver that includes a pluggable optical transceiver and a host connector cover of a host connector.

### BACKGROUND ART

Various pluggable systems for an optical transceiver and a host connector have been disclosed in prior arts. For instance, the United State Patent, the U.S. Pat. No. 7,710,734, has disclosed a platform including a pluggable optoelectronic module and a host system installing the module. The optoelectronic module includes a circuit board mounting optical and electrical components thereon, a housing for enclosing the board therein and an electrical plug electrically connected with the board and extruding from a rear of the housing. The host system includes a host connector to be mated with the electrical plug and a host connector cover for covering the host connector. The host connector cover provides an opening in the front thereof through which the electrical plug passes to be mated with the host connector. Moreover, the front of the host connector cover provides a gasket surrounding the opening

The optical transceiver disclosed in the prior art above described is set on the host system by mating the electrical plug or module connector with the host connecter as deforming the gasket provided in a front of the connector cover. The deformed gasket may shield a gap inherently caused between the rear of the housing of the optical transceiver and the host connector to prevent EMI radiation from leaking from the module connector and the host connector.

In such a configuration described above, a substantial force is necessary to set the optical transceiver on the host system and to mate the module connector with the host connector as resisting the repulsive force caused by the deformed gasket. Lesser force applied to the optical transceiver may cause incomplete mating between two connectors, which may bring poor quality in the communication between the optical transceiver and the host system. The optical transceiver disclosed in the prior art above provides a hollow gasket to reduce the repulsive force caused thereby.

An embodiment of the present invention is to provide a mechanism to reduce further the repulsive force caused by the gasket provide in the host connector without degrading the EMI radiations leaked around the module connector and the host connector.

### SUMMARY OF INVENTION

One aspect of the present invention relates to a pluggable system for an optical transceiver. The pluggable system according to embodiments of the present invention includes an optical transceiver and a host connector. The optical transceiver may have a housing for installing a circuit board with an electrical plug therein. The housing has a rear from which the electrical plug extrudes outwardly. The host connector, which is provided in the host system, may include a connector body and a cover to covering the connector body. The cover may have an opening and a groove surrounding the opening The electrical plug of the optical transceiver may pass through the opening to mate with the connector body. The groove may set a gasket therein. A feature of the present embodiment is that the housing provides a periodic structure arranged along the groove, and the rear of the housing comes in contact with the gasket in restricted portions.

In the pluggable system according to an embodiment, when the optical transceiver is set on the host system, namely, the electrical plug is mated with the host connector as deforming the gasket in the groove, the repulsing force caused by the gasket may be weakened because only limited portions of the rear may come in contact with the gasket.

The periodic structure formed in the rear of the housing may be a plurality of hollows or a plurality of projections. The rear of the housing may come in contact with the gasket only in restricted portions except for the hollows, or portions of the projections. Moreover, the width of each of the hollows, or the pitch to the neighbor projections are set to be shorter than a quarter wavelength of a signal transmitted between the electrical plug of the optical transceiver and the host connector; accordingly, EMI radiations with wavelengths thereof longer than the width or the pitch above may be prevented from leaking from a rear portion of the optical transceiver.

Another aspect of the present invention also relates to a pluggable system for an optical transceiver that includes the optical transceiver and a host connector. The optical transceiver may have a housing that installs a circuit board with an electrical plug therein. The housing has a rear from which the electrical plug extrudes. The host connector provided in the host system may include a connector body and a cover to covering the connector body. The cover may have an opening and a groove surrounding the opening. The electrical plug of the optical transceiver may pass through the opening to mate with the connector body. The groove may set a gasket therein.

A feature of the present embodiment is that the groove has a plurality of hollows in the bottom thereof; accordingly, the gasket comes in contact with the bottom only in restricted portions except for the hollows. Because the area where the gasket comes in contact with the bottom of the groove may be limited only in portions except for the hollows, the repulsive force caused by the gasket may be weakened. Moreover, each of the hollows has a width shorter than a quarter wavelength of a signal transmitted between the electrical plug and the host connector.

Still another aspect of the present invention relates to an optical transceiver set on the host system. The optical transceiver may include an optical subassembly, a circuit board and a housing. The optical subassembly may convert a signal between an optical and electrical format. The circuit board, which may mount an electronic circuit communicating with the optical subassembly, may have an electrical plug to be mated with a host connector provided in the host system. The housing may install the optical subassembly and the circuit board therein. The housing may have a rear, from which the electrical plug is extended. A feature of the optical transceiver according to an embodiment of the invention is that the rear provides a periodic structure and comes in contact with the host connector only in restricted portions corresponding to the periodic structure.

The periodic structure may be a plurality of hollows or projections. The rear of the housing may come in contact with the host connector only in restricted portions except for the hollows, or only in the projections. The width of each of the hollows, or the pitch between neighbors of the projections may be set shorter than a quarter wavelength of a signal transmitted through the electrical plug, which may prevent EMI radiations from leaking from the electrical plug.

### BRIEF DESCRIPTION OF DRAWINGS

These and other aspects of the invention may be understood by reference to the following detailed description, taken in conjunction with the accompanying drawings, wherein:

FIG. 1 is a perspective view of a pluggable system according to an embodiment of the invention;

FIG. 2 is a perspective view of an optical transceiver viewed from a front top, which is applicable to the pluggable system shown in FIG. 1;

FIG. 3 is a perspective view of the optical transceiver viewed from a rear bottom thereof;

FIG. 4 is a perspective view of the host system to be plugged with the optical transceiver shown in FIGS. 2 and 3;

FIG. 5 is a perspective view of a host connector installed on the host system shown in FIG. 3;

FIG. 6 magnifies a region A of the host connector shown in FIG. 4;

FIG. 7 shows a cross section of the host connector taken along the line VII-VII appeared in FIG. 4;

FIG. 8 shows a cross section of the pluggable system taken along the ling VIII-VIII appeared in FIG. 1;

FIG. 9 is a perspective view of a rear of the optical transceiver;

FIG. 10 shows a cross section of the pluggable system taken along the ling X-X appeared in FIG. 8;

FIG. 11 shows a rear of the optical transceiver, which is modified from those shown in FIGS. 2 and 9;

FIG. 12 is a cross section of the modified pluggable system taken along the line X-X appeared in FIG. 8;

FIG. 13 is a perspective view of the pluggable system according to the second embodiment of the invention;

FIG. 14 shows a rear of the optical transceiver of the second embodiment shown in FIG. 13;

FIG. 15 shows the host system shown in FIG. 13 according to the second embodiment of the invention;

FIG. 16 shows a host connector of the second embodiment;

FIG. 17 shows a cross section taken along the line VI-VI appeared in FIG. 15;

FIG. 18 shows a cross section of the pluggable system of the second embodiment, which is taken along the line VIII-VIII appeared in FIG. 13;

FIG. 19 shows a cross section of the pluggable system of the second embodiment, which is taken along the line IX-IX appeared in FIG. 18;

FIG. 20 is a perspective view of a host connector modified from the host connector of the second embodiment shown in FIG. 15; and

FIG. 21 shows a cross section of the pluggable system implementing the host connector of the modified embodiment shown in FIG. 20, where the cross section is taken along the line IX-IX appeared in FIG. 18.

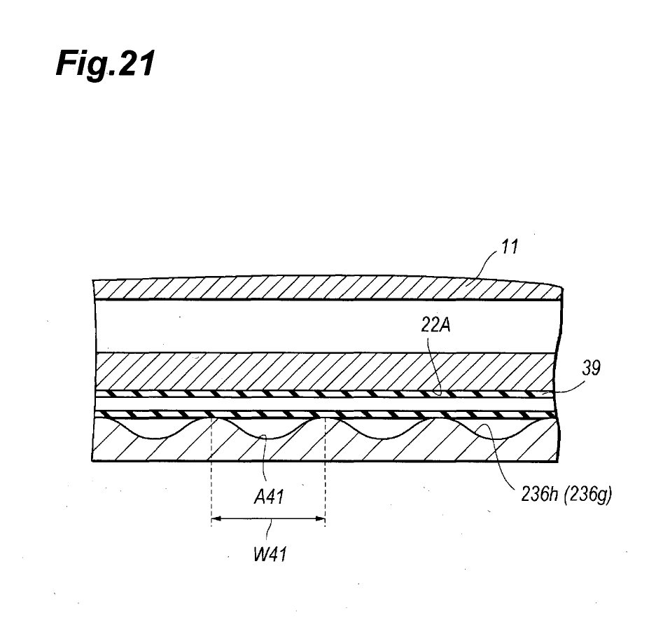

### DESCRIPTION OF EMBODIMENTS

Next, some embodiments of an optical transceiver and an optical connector according to the present invention will be described as referring to drawings. In the descriptions of the drawings, numerals or symbols same or similar to each other will refer to elements same or similar to each other without overlapping explanations.

### First Embodiment

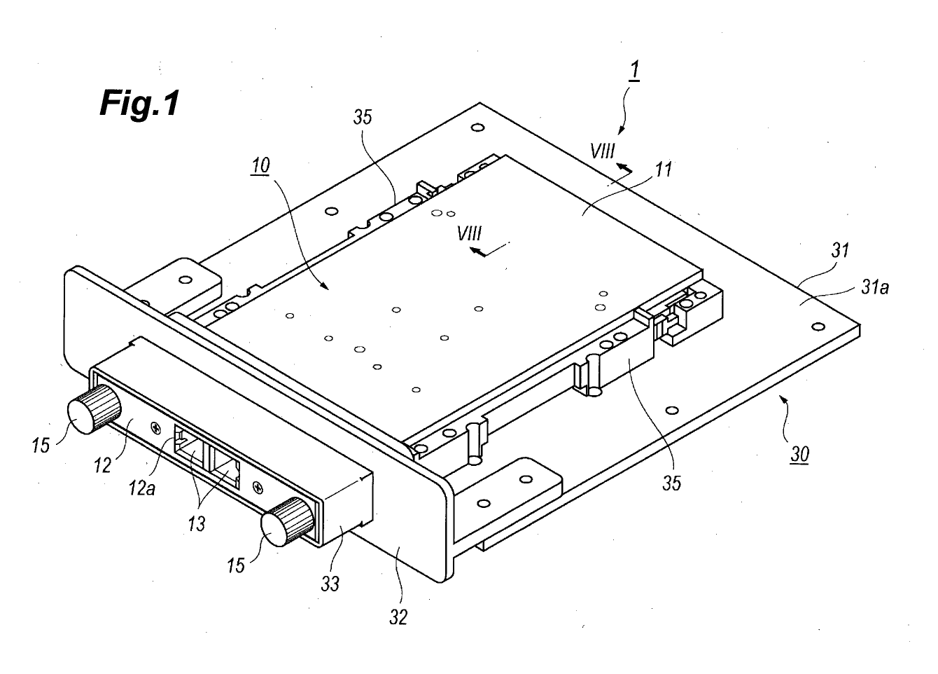

FIG. 1 is a perspective view of a pluggable system 1 according to the first embodiment of the present invention, where the pluggable system includes an optical transceiver 10 and the host system 30. The optical transceiver 10 has a type of, what is called, the pluggable optical transceiver following the standard of the CFP.

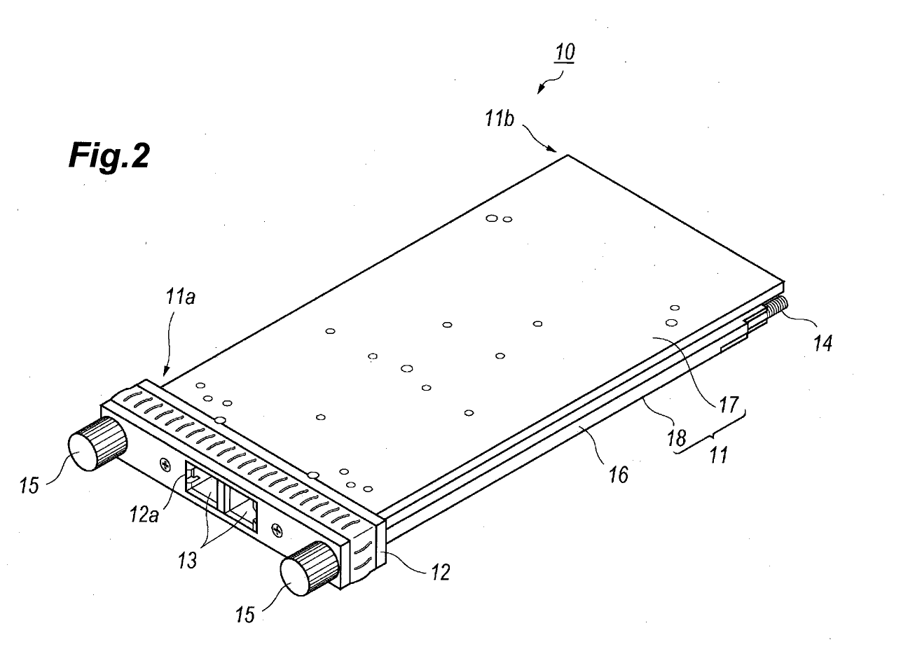

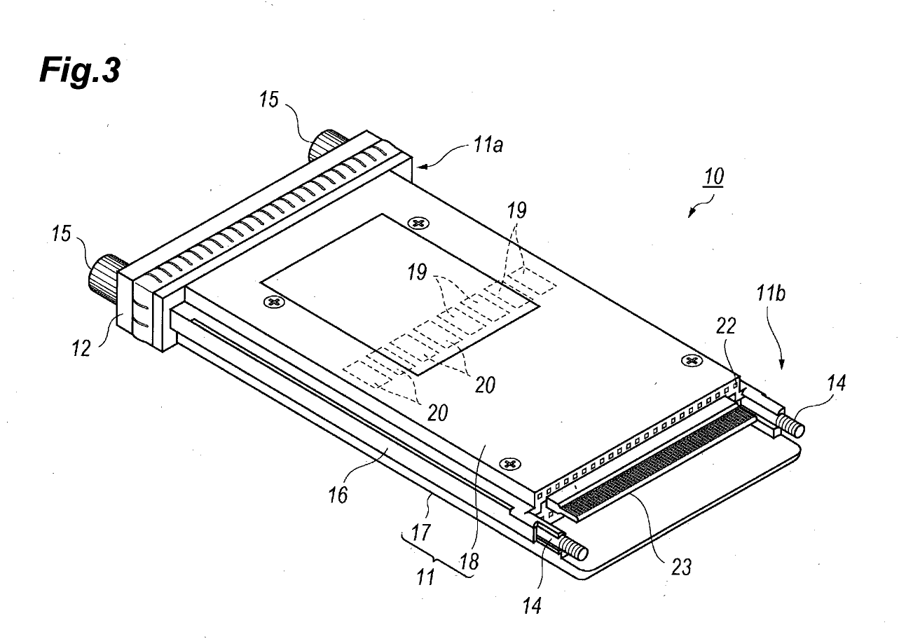

FIG. 2 is a perspective view of the optical transceiver 10 viewed from the front top; while, FIG. 3 shows the optical transceiver 10 viewed from the rear bottom. The optical transceiver 10, as illustrated in FIGS. 2 and 3, includes a housing 11 and a front cover 12 attached to the front end 11a of the housing 10. The housing 11 may be made of, for instance, aluminum or zinc from viewpoints of the heat dissipation and the castability. The description presented below assumes, only by the explanation sake, that the front is a side where the front cover 12 is assembled; while, the rear is the other side where the electrical plug 23 is disposed. The front cover 12 provides an opening 12a in a center of the lateral direction, through which the optical connector 13 exposes. Both sides of the front cover 12 protrude a knob 15 secured in a tip of the fastening screw 14. The fastening screw 14 also passes through the housing 11 to protrude in the rear end 11b of the housing 11. The optical transceiver 10 may be installed on the host system 30 by fastening the screw 14 with a female screw provided in a host connector 34, which will be later in the specification. The fastening screw 14 is enclosed within a rib 16 extending from the front end 11a to the rear end 11b in respective sides of the housing 11. The rib 16 may be fit with a rail 35 provided in the host system. Thus, sliding the housing 11 as mating the rib 16 with the rail 35 of the host system 30, the installation of the optical transceiver 10 in the host system may be facilitated.

The housing 11 includes a top housing 17 and a bottom housing 18. Optical and electrical components may be installed in a space formed between these two housings, 17 and 18. Optical components are typically the optical connector or optical receptacle 13 described above, a receiver optical subassemblies 19 (ROSAs), a transmitter optical subassemblies 20 (TOSAs); while, electrical components are typically electronic circuits communicating with the TOSAs and the ROSAs, and a circuit board 21 for mounting the electronic circuit. Specifically, a clock recovery circuit communicates with the ROSAs 19 to recover clock components from a received optical signal; while, a driver communicates with the TOSAs 20 to drive a semiconductor device in the TOSA 20.

The housing 11 includes a rear 22 extending in both housings, 17 and 18. The rear 22 faces the front of the host connector 34 when the optical transceiver 10 is set in the host system 30. The electrical plug 23, which provides a plurality of electrodes, extrudes from the rear 22 to couple the ROSA 19 and the TOSA 20 electrically with the host system 30 via the circuit on the board 21; while the electrical plug 23 is mated with the host connector 34 of the host system 30. Thus, the host system 30 may communicate with the optical transceiver 10.

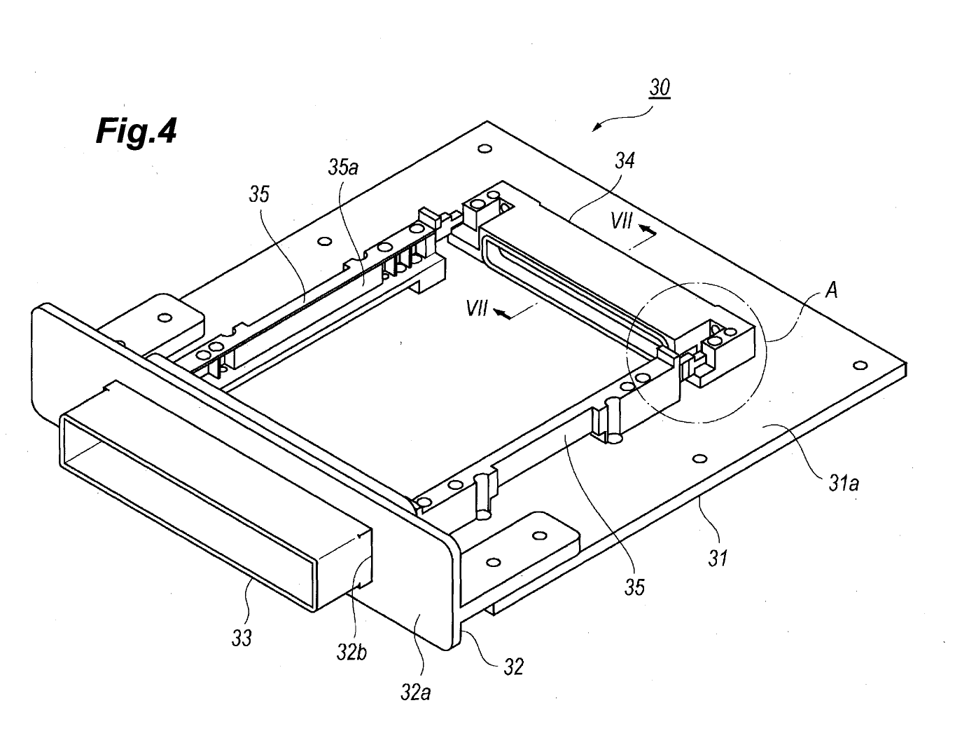

FIG. 4 is a perspective view of the host system 30 shown in FIG. 1. The host system 30 provides the board 31 assembling the front panel 32. The front panel 32 has an opening 32b in a center thereof, where the opening 32b accompanies therewith a cowling 33 having a rectangular cross section. The optical transceiver 10 may be set on the primary surface 31a of the board 31 through the cowling 32b. The primary surface 31a further provides a pair of rails 35 extending from respective sides of a rear surface of the front panel 32 to both sides of the host connector 34. The rail 35 has a guide 35a in an inner wall thereof facing the other rail 35. The guide 35a may receive the rib 16 in the corresponding side of the housing 11; thus, the optical transceiver 10 may be guided on the host system 30. The host connector 34 may be made of zinc (Zn) or aluminum (Al) from the viewpoints of hardness and the fluidity

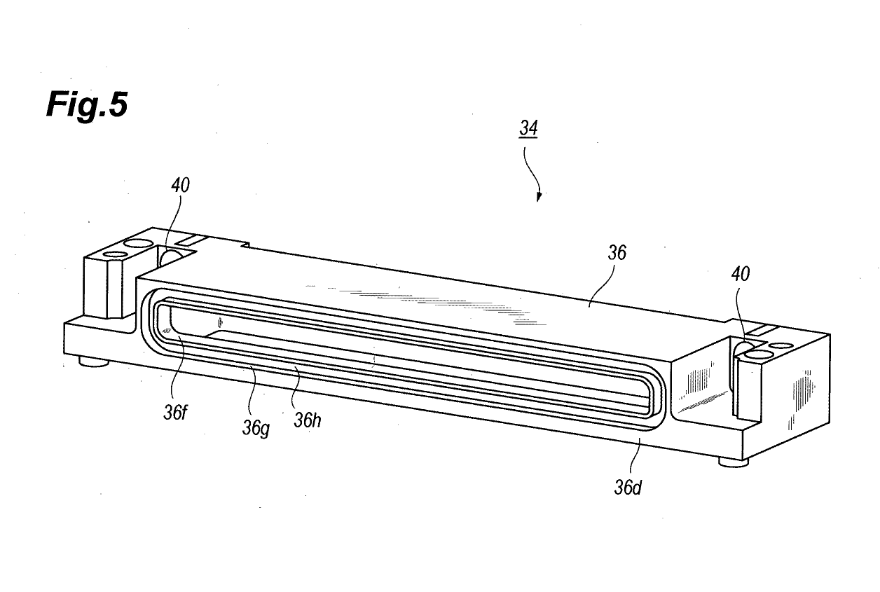

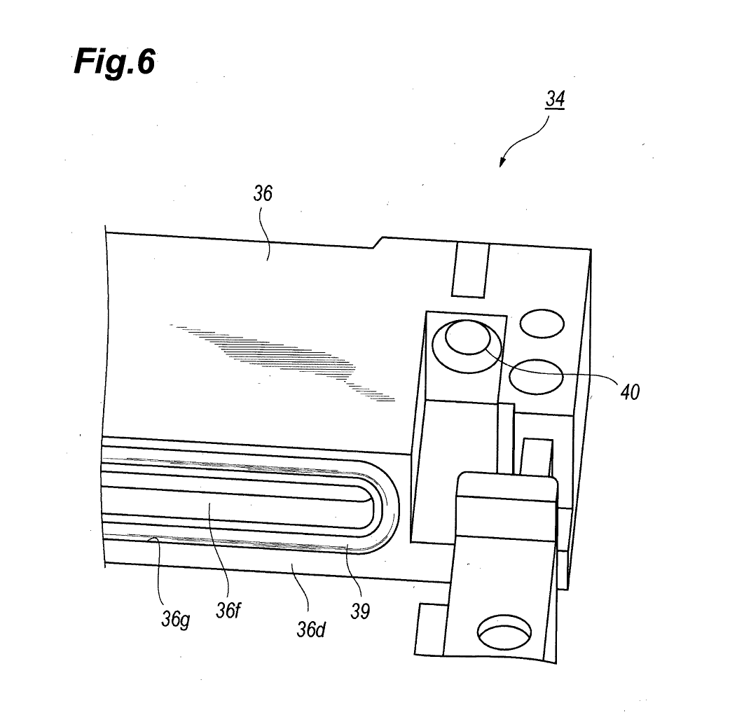

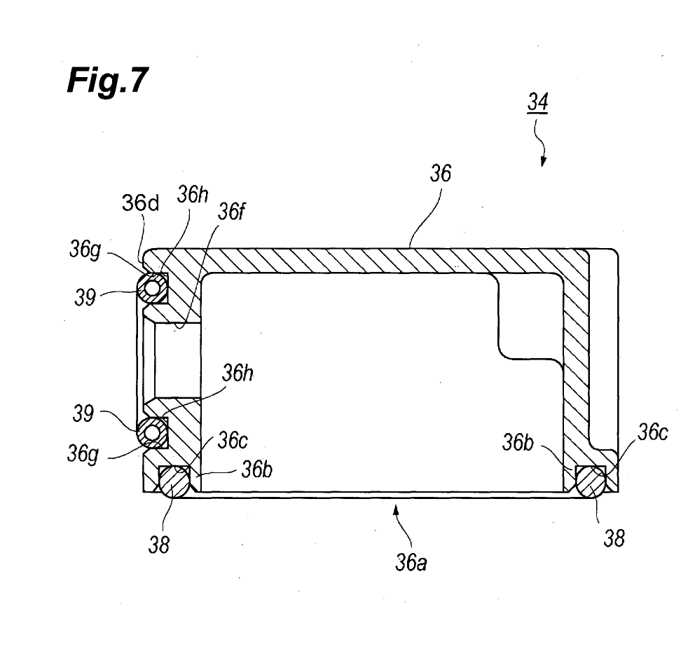

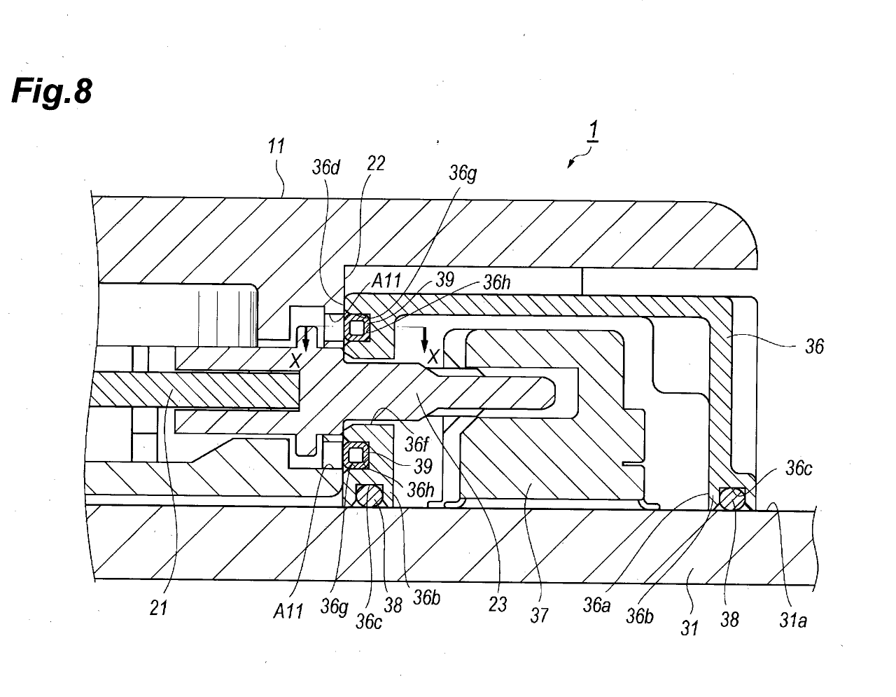

FIG. 5 is a perspective view of the host connector 34; FIG. 6 magnifies a portion A appeared in FIG. 4; and FIG. 7 shows a cross section taken along the line VII-VII also appeared in FIG. 4. The host connector 34 includes a cover 36 in which the connector body 37 to be mated with the electrical plug 23 of the optical transceiver 10 is set (see to FIG. 8). Specifically, the cover 36 has a rectangular shape, and one of surfaces thereof facing the primary surface 31a of the board 31 has an opening 36a. The periphery 36b of the opening 36a provides a groove 36c into which a gasket 38 is set. The gasket 38 in a portion thereof protrudes from the groove 36c as being set therein. Setting the host connector 34 on the board 31, a gap inherently formed between the cover 36 and the board 31 may be sealed by deforming the gasket 38 elastically. The gasket 38 may be made of silicone rubber containing electrically conductive filler such as aluminum, silver, carbon, and so on.

The front 36d of the cover 36 also forms an opening 36f. The front 36d faces the rear 22 of the housing 11 of the optical transceiver 10 when the electrical plug 23 set in a space of the cover 36 is mated with the connecter body 37 as passing the opening 36f. The front 36d in a periphery thereof provides a grove 36g to surround the opening 36f; where a bottom 36h of the groove 36g is formed in substantially flat to set another gasket 39 therein.

The gasket 39 with a tubular shape, may be made of silicon rubber containing electrically conductive material as a filler, such as aluminum, silver, carbon, and so on. This gasket 39 in a portion thereof also extrudes from the front 36d as being set in the groove 36g. Accordingly, setting the optical transceiver 10 on the host system 30, namely, mating the electrical plug 23 with the connector body 37 as inserting the plug 23 within the space of the cover 36 from the opening 36f, the gasket 39 may be crushed by being pushed against the bottom 26h of the groove 36g by the rear 22 of the housing 11; then, a gap inherently caused between the rear 22 and the front 36d may be sealed by the deformed gasket 39.

Referring to FIGS. 5 and 6 again, each of the sides of the cover 36 provides a female screw 40 to be fastened with the male screw 14 of the optical transceiver 10. The optical transceiver 10 is set on the board 31 as inserting the transceiver 10 through the cowling 33 to be guided along the rail 35. Concurrently, the electrical plug 23 mates with the connector body 37 as being set within the space of the cover by passing through the opening 36f of the front 36d. Fastening the male screw 14 of the optical transceiver 10 with the female screw 40 of the cover 36, the optical transceiver 10 may be set in the position on the host system 30.

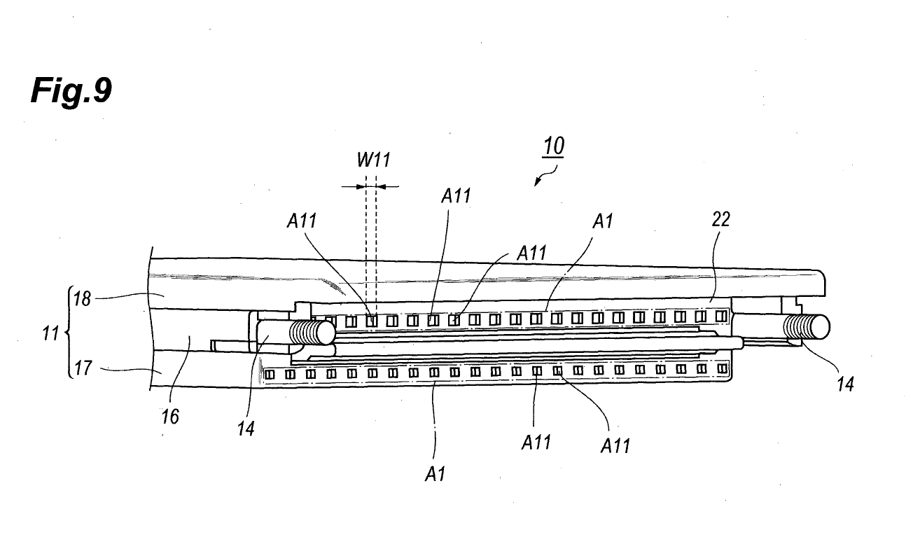

FIG. 9 shows the rear of the optical transceiver. The rear 22 of the housing 11 includes an area A1 laterally extending along the periphery thereof. The area A1 faces the gasket 39 when the electrical plug 23 is inserted in the space of the cover 36 from the opening 36f and mated with the connector body 37. The area A1 has a plurality of hollows A11 laterally arranged; accordingly, the rear 22 of the housing 11 comes in contact with the gasket 39 only in portions except for the hollows A11. Although the embodiment shown in FIG. 9 has the hollows with a rectangular shape and laterally arranged with substantially a constant pitch, the shape of the hollows not restricted to the rectangle and the hollows may have a variable pitch to the neighbors.

A width W11 of respective hollows A11 may be set shorter than a quarter wavelength λ/4 of signals transmitted between the electrical plug 23 and the connector body 37. For instance, when the host system 30 transmits a signal of 10 Gbps whose primary wavelength becomes about 30 mm, the width W11 of the hollows A11 may be set shorter than about 7.5 mm.

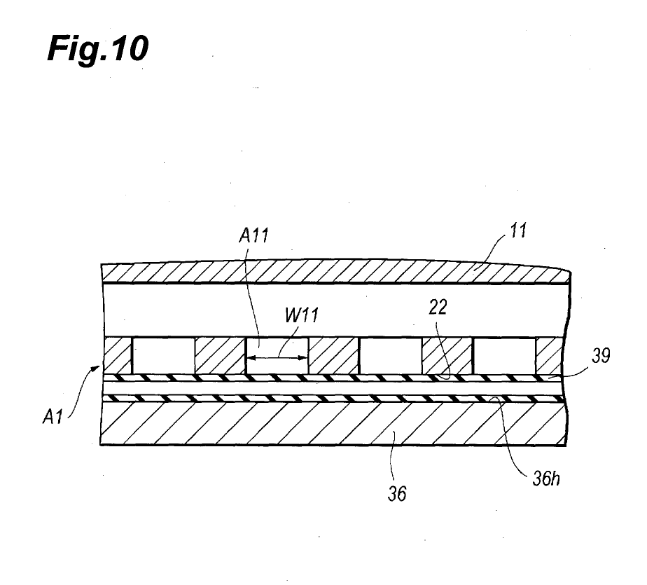

FIG. 10 shows a cross section of the rear 22 of the housing 11 taken along the line X-X appeared in FIG. 8. As shown in FIGS. 8 to 10, when the optical transceiver 10 is set on the host system 30 as mating the electrical plug 23 with the connector body 37, the rear 22 of the housing 11 in a whole portion thereof does not come in contact with the gasket 39, only portions except for the hollows A11 in the area A1 may come in contact with the gasket 39. Accordingly, the area of the rear 22 in contact with the gasket 39 decreases compared with a case where the rear 22 does not have any hollows A11, namely, the rear 22 is substantially flat. Under such a condition above described, the repulsive force affected to the rear 22 of the housing 11 from the gasket 39 may decrease; then, the electrical plug 23 may mate with the connector body 37 by a relatively weaker strength, and the communication errors between the host system 30 and the optical transceiver 10 may be decreased.

Moreover, the hollows A11 has the width W11 shorter than the quarter wavelength of signals transmitted through the electrical plug 23 and the connector body 37; then even when a faint gap is formed between the rear 22 and the gasket 39, EMI radiations whose quarter wavelengths are longer than the width W11 above described may be prevented from leaking from the optical transceiver 10.

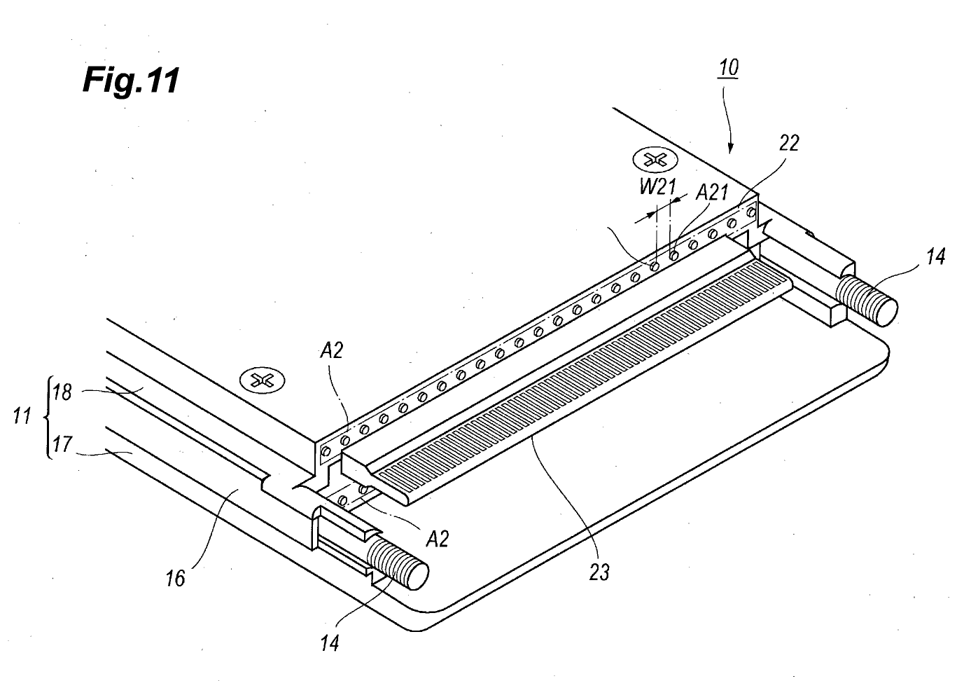

The area A1 in the rear 22 of the optical transceiver 10 is not restricted to those arrangement shown in the figures. For instance, FIG. 11 shows another arrangement of the area A2 in the rear 22. The area A2 includes a plurality of projections A21 laterally disposed in the rear 22. The projections A21 has a pillar shape with a pitch W21 same as the pitch W11 of the hollows A11 of the aforementioned embodiment. In the embodiment shown in FIG. 11, the top of the projections A22 levels in the rear 22 of the former embodiment; that is, a height of the projections A2 is substantially equal to a depth of the hollows A1 of the aforementioned embodiment.

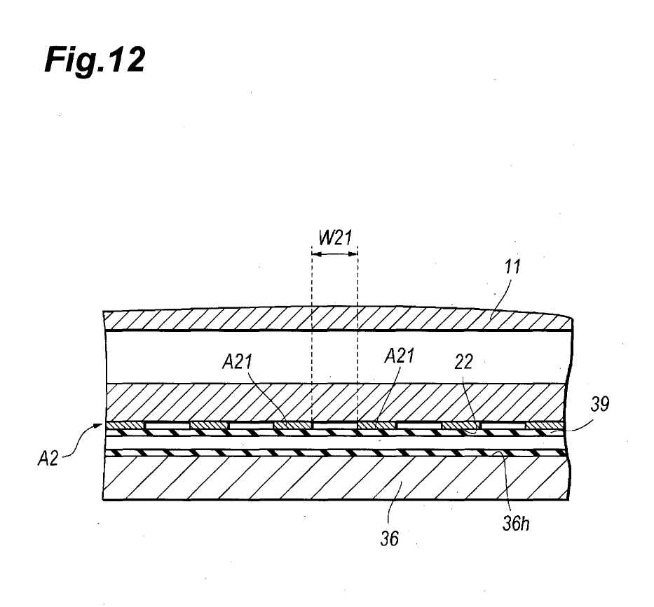

When the optical transceiver 10 is set on the host system 30, the rear 22 of the housing 11 in the whole surface is not in contact with the gasket 39 as shown in FIG. 12, and only the top of the projections A21 come in contact with the gasket 39. Moreover, because the pitch between the projections A21 is set to be equal to the width of the hollows A11 in the former embodiment, the EMI radiation with the quarter wavelength λ/4 thereof longer than the pitch between the neighbor projections A21 may be prevented from leaking from the rear 22 of the housing 11.

### Second Embodiment

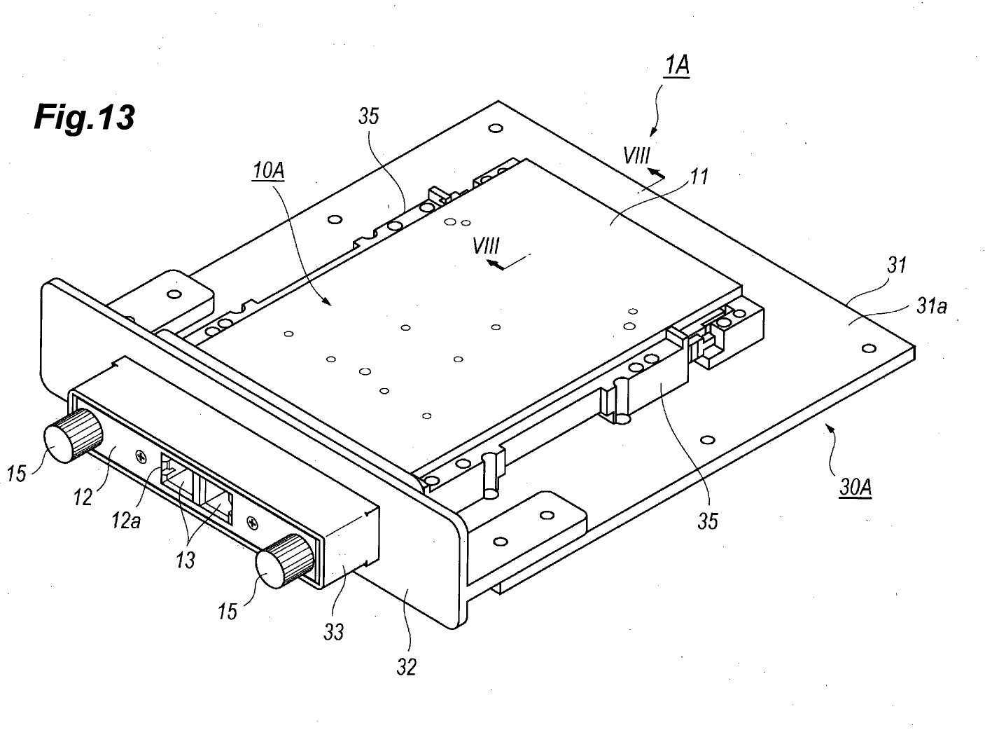

Next, a pluggable system including an optical transceiver and a host connector cover according to the second embodiment of the invention will be described. FIG. 13 shows the pluggable system of the second embodiment where the pluggable system 1A includes an optical transceiver 10A and the host system 30A.

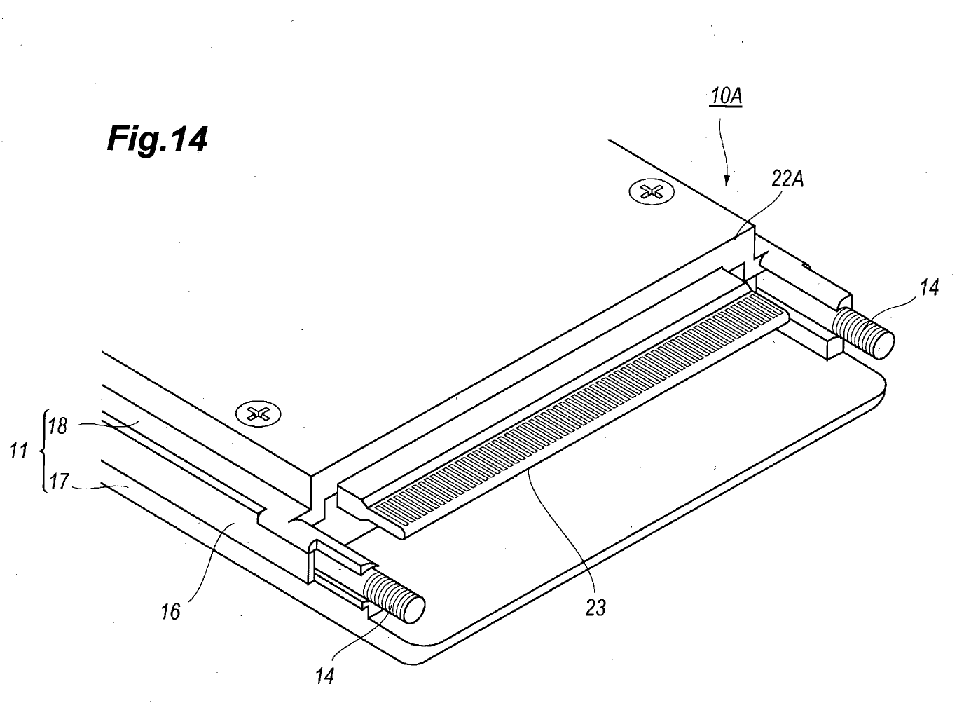

FIG. 14 is a perspective view concentrating on a rear portion of the optical transceiver 10A that provides, instead of the rear 22 of the former embodiment, the rear 22A. Other arrangements of the optical transceiver 10A are the same as those of the aforementioned optical transceiver 10. The rear 22A is substantially flat, namely, the rear 22A of the present embodiment may be distinguishable from the former embodiment that the rear 22A provides no hollows 11A and projections A21.

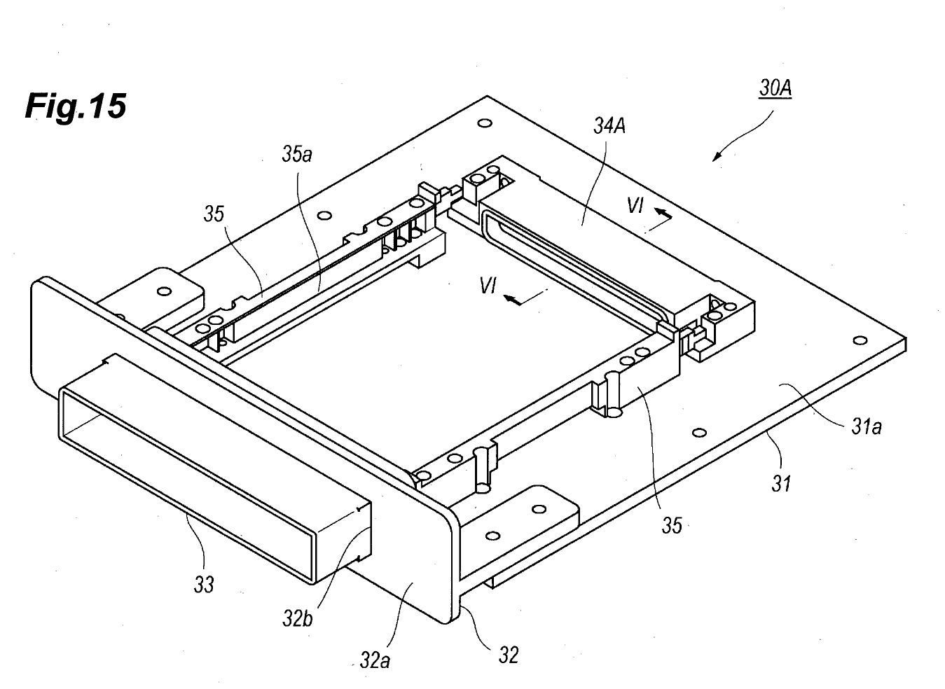

FIG. 15 is a perspective view showing the host system 30A shown in FIG. 13. The host system 30A is distinguishable from the aforementioned host system 30 in that the host system 30A of the embodiment provides a host connector 34A. Other arrangements except for the host connector 34A are the same as those of the aforementioned embodiment.

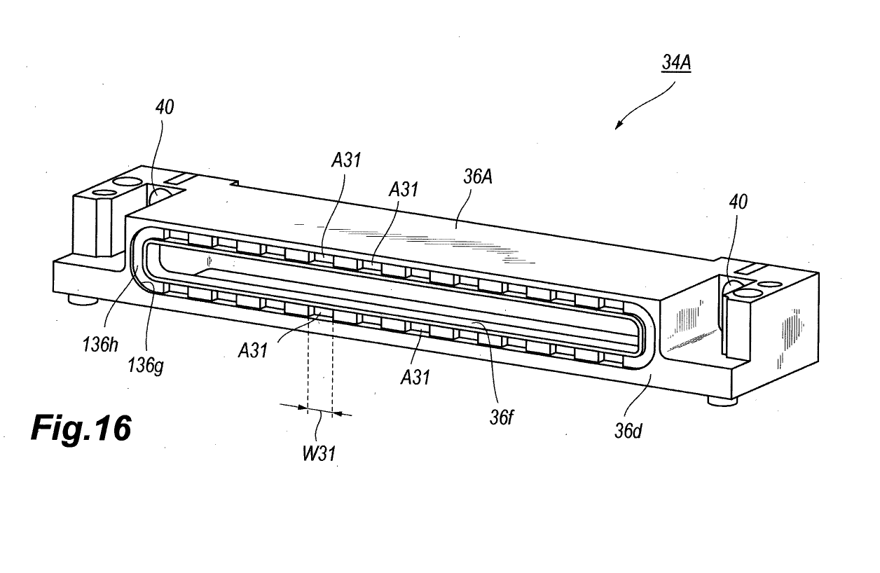

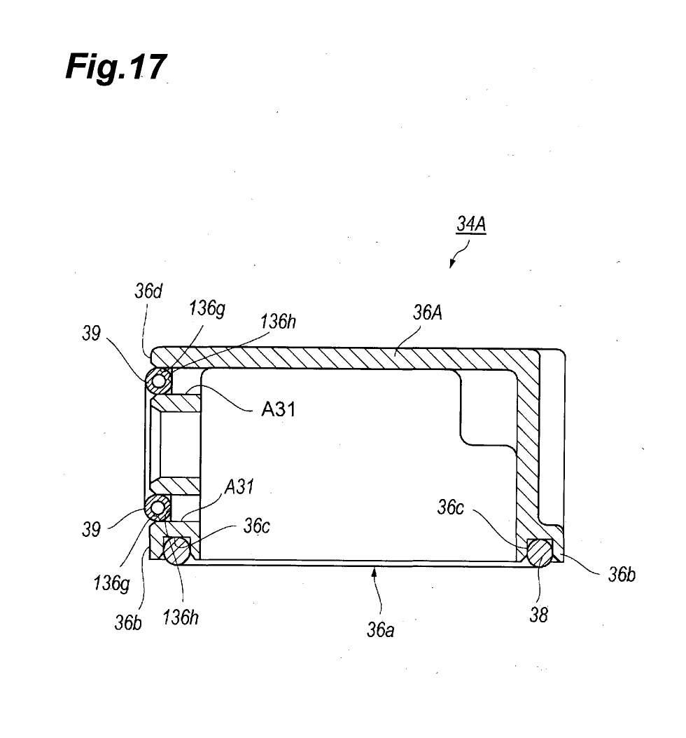

FIG. 16 is a perspective view of the host connector 34A, while, FIG. 17 shows a cross section of the host connector 34A taken along the line VI-VI appeared in FIG. 15. The host connector 34A of the present embodiment provides a cover 36A to enclose the connector body 37 to be mated with the electrical plug 23 of the optical transceiver 10A. The cover 36A also has a rectangular shape but one surface thereof provides an opening 36a facing the primary surface 31a of the board 31. Peripheries surrounding the opening 36a form a ringed groove 36c.

The groove 36c sets the gasket 38 therein as that of the aforementioned embodiment. A portion of the gasket 38 protrudes from the groove 36c, which may seal that a gap inherently formed between the peripheries 36b and the primary surface 31a of the board 31 when the host connector 34A is set on and fixed to the primary surface 31a.

The front 36d of the cover 36A also forms another opening 36f. When the electrical plug 23 is inserted into the space of the cover 36A to be mated with the connector body 37, the front 36d faces against the rear 22A of the optical transceiver 10A. The front 36d also provides another ringed groove 136g to surround the opening 36f, in which another gasket 39 is set. This gasket 39 in a portion thereof protrudes form the groove 136g as it is set within the groove 136g. Accordingly, setting the optical transceiver 10A on the host system 30A, equivalently, mating the electrical plug 23 with the connector body 37, the rear 22A of the housing 11 pushes the gasket 39 against the bottom 136h of the groove 136g to crush the gasket 39 elastically. Then, a gap inherently formed between the rear 22A and the front 46d of the cover 36A may be tightly sealed.

As shown in FIGS. 16 and 17, the bottom 136h of the groove 136g provides a plurality of hollows A31. Accordingly, the gasket 39 may come in contact with the bottom 136h only in portions except for the hollows A31. These hollows A31 of the present embodiment may be through holes with a rectangular shape and having a constant pitch between neighbors along the groove 136g.

Each of hollows A31 has a width along the groove 136g shorter than a quarter wavelength λ/4 of the signals transmitted through the connector body 37 and the electrical plug 23. In an example, when the signal has 10 Gbps in the transmission speed thereof, the width of the hollows A31 may be shorter than about 7.5 mm, which corresponds to the quarter wavelength of the signal of 10 GHz.

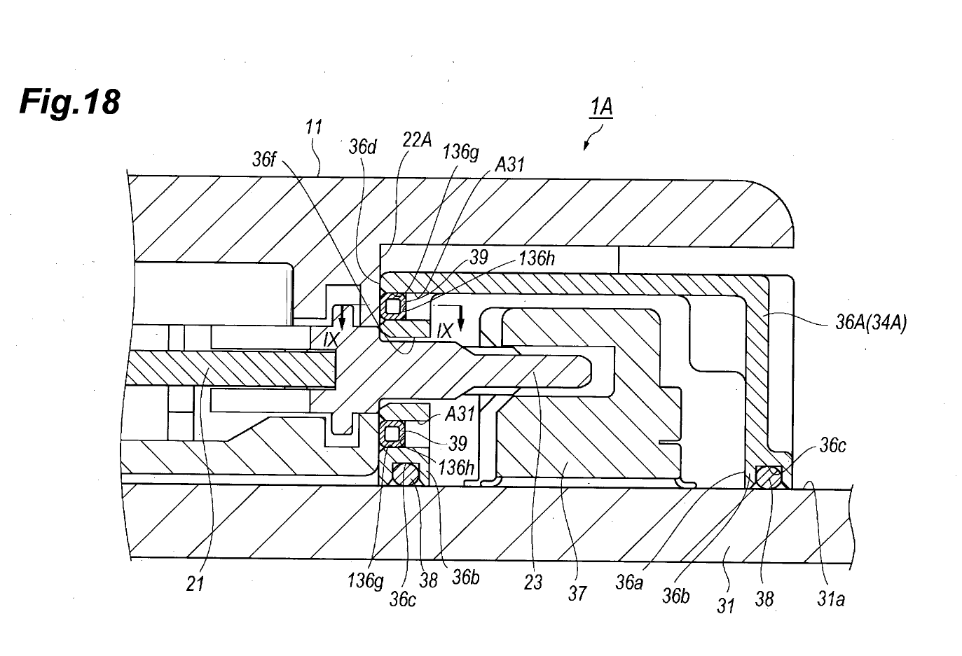

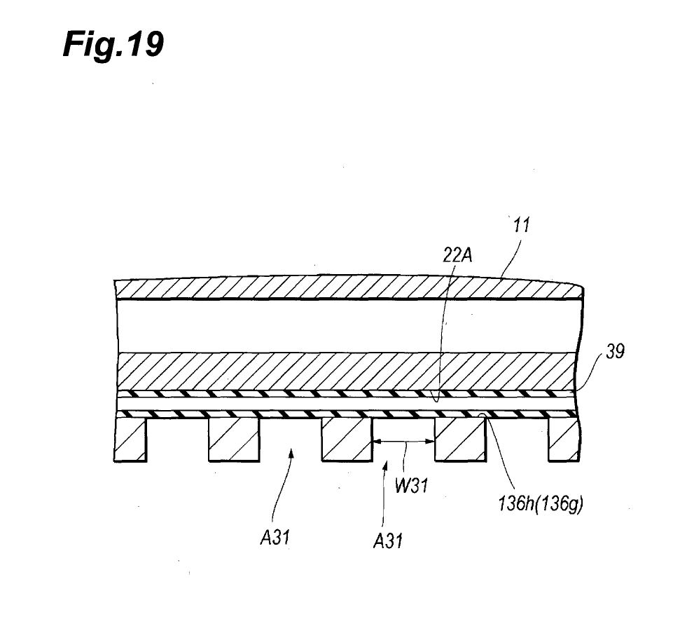

FIG. 19 shows a cross section taken along the line IX-IX appeared in FIG. 18. The cover 36A to enclose the connector body 37 therein provides front 36d including the opening 36f and the ringed groove 136g surrounding the opening 36f. The groove 136g that sets the gasket 39 therein has the bottom 136h with a plurality of hollows A31. Then, the bottom 136h may come in contact with the gasket 39 only in portions except for the hollows A31, which means that the area of the bottom 136h coming in contact with the gasket 39 may be narrowed compared with a case when the bottom 136h has no hollows A31, namely, a case where the bottom 136h is substantially flat. Accordingly, a repulsive force of the gasket 39 exerted against the bottom 136h may be reduced.

When the optical transceiver 10A is set on the host system 30A as mating the electrical plug 23 with the connector body 37 to push the gasket 39 against the bottom 136h of the groove 136g by the rear 22A of the housing 11, the repulsive force against the rear 22A caused by the gasket 39 may be reduced, which allows the setting of the optical transceiver 10A on the host system 30A to be facilitated, and the communication between the optical transceiver 10A and the host system 30A via the electrical plug 23 and the connector body 37 may be further reliable.

Moreover, the width W31 of the hollows A31 in the bottom 136h of the groove 136g is set shorter than the quarter wavelength λ/4 of the signal transmitted through the electrical plug 23 and the connector body 37. Accordingly, even when the electrical plug 23 is mated with the connector body 37, the gap formed between the rear 22A and the gasket 39 may be restricted to be shorter than the quarter wavelength λ/4 of the signal, which may restrict the EMI radiation leaking from the gap.

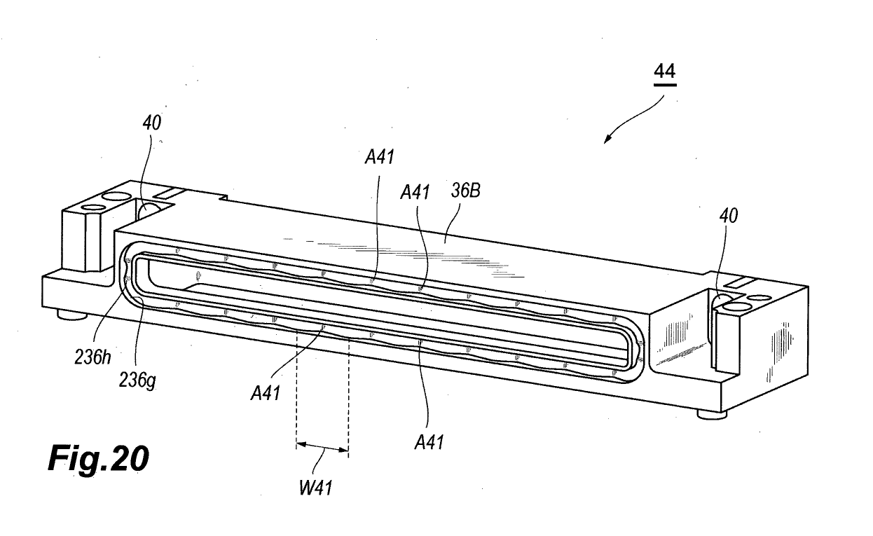

The embodiment described above provides the hollows A31 with a rectangular shape. However, the shape of the hollows A31 is not limited to a rectangle. For instance, another shape such as shown in FIG. 20 may be applicable. Specifically, the groove 236g has a corrugated bottom 236h formed by the hollows A41. The bottom 236h may be formed in corrugated and the hollow A41 corresponds to an area between the tops of the corrugation. The width W41 of the hollow A41, namely, a pitch of the corrugation, may be same as the width W31 of the aforementioned hollow A31.

In the modified embodiment shown in FIG. 20, almost whole portion of the hollow A41 does not come in contact with the gasket 39; then the area of the portion of the hollow A41 coming in contact with the gasket 39 may be further reduced. The repulsive force caused by the gasket when it is pushed against the bottom 146h of the groove 146g may be further reduced. Moreover, the width W41 of the hollow A41 is set in the similar manner to those described above, the communication between the optical transceiver 10A and the host system 30A via the electrical plug 23 and the connector body 37 may be further reliable.

In the foregoing detailed description, the spirits of the present invention has been described with reference to specific exemplary embodiments thereof. It will, however, be evident that the invention is not limited to those optical transceivers, the host connectors, and the bodies. Various modifications and changes for those components may be made thereto without departing from the broader spirit and scope of the present invention.

For instance, the specification above describes that the widths, W11, W31 and W41, of respective hollows, A11, A31 and A41, or the width W21 between the projections A21 are preferably set to be shorter than the quarter wavelength λ/4 of the signal transmitted through the electrical plug 23 and the connector body 37, and those width may be shorter than about 7.5 mm when the signal has the transmission speed of 10 Gbps. However, the width or pitch is not limited to those conditions. When the EMI radiation caused by the signal has other frequency components, the width of the hollow or projection may be optionally set to those components. When the EMI radiation with frequency components of 40 GHz is considered, the width may be set to be shorter than about 1.875 mm corresponding to the quarter wavelength of the 40 GHz signal.

Although the hollows A11 of the first embodiment have a rectangular shape, optional shapes may be applicable to the hollow A11. For instance, the hollows A11 may be circular through holes or circular hollows with a bottom. Similarly, the projections A21 according to the first embodiment may be rectangular projections, and the hollows A31 of the third embodiment is not limited to rectangular through holes but circular through holes may be applicable as the hollows.

Thus, the present embodiments of the invention should be considered in all respects as illustrative and not restrictive, the scope of the invention to be determined by the appended claims and their equivalents.

1. A pluggable system, comprising:
an optical transceiver with a housing that encloses a circuit board with an electrical plug therein, the housing having a rear from which the electrical plug extrudes; and
a host connector provided in a host system, the host connector includes a connecter body and a cover for covering the connector body, the cover having, in a surface facing the rear of the optical transceiver, an opening through which the electrical plug passes to mate with the connector body and a groove surrounding the opening and setting a gasket therein,
wherein the rear of the housing provides a periodic structure arranged along the groove in the cover, the rear of the housing coming in contact with the gasket in restricted portions.

2. The pluggable system of claim 1,
wherein the periodic structure includes a plurality of hollows, the rear coming in contact with the gasket in portions except for the hollows.

3. The pluggable system of claim 2,
wherein each of hollows has a width shorter than a quarter wavelength of a signal transmitted between the electrical plug and the host connector.

4. The pluggable system of claim 2,
wherein each of the hollows is a through hole extending from the rear to an inside of the housing.

5. The pluggable system of claim 1,
wherein the periodic structure includes a plurality of projections, the rear coming in contact with the gasket in portions of the projections.

6. The pluggable system of claim 5,
wherein the projections has a pitch to nearest neighbors shorter than a quarter wavelength of a signal transmitted between the electrical plug and the host connector.

7. The pluggable system of claim 5,
wherein each of the projections has a pillar shape.

8. A pluggable system, comprising:
an optical transceiver with a housing that encloses a circuit board with an electrical plug therein, the housing having a rear from which the electrical plug extrudes; and
a host connector provided in a host system, the host connector including a connecter body and a cover for covering the connector body, the cover having, in a surface facing the rear of the optical transceiver, an opening through which the electrical plug passes to mate with the connector body and a groove surrounding the opening and setting a gasket therein,
wherein the groove has a periodic structure in a bottom thereof.

9. The pluggable system of claim 8,
wherein the periodic structure in the bottom includes a plurality of hollows.

10. The pluggable system of claim 9,
wherein the gasket set in the groove comes in contact with the bottom of the groove in portions except for the hollows.

11. The pluggable system of claim 9,
wherein each of the hollows has a width shorter than a quarter wavelength of a signal transmitted between the electrical plug and the host connector.

12. The pluggable system of claim 9,
wherein each of the hollows is a through hole extending from the bottom of the groove to an inside of the cover.

13. The pluggable system of claim 8,
wherein the periodic structure includes a corrugated bottom.

14. The pluggable system of claim 13,
wherein the gasket comes in contact with the bottom of the grove in top portions of the corrugated structure.

15. The pluggable system of claim 13,
wherein the corrugate structure has a pitch between tops neighbor to each other shorter than a quarter wavelength of a signal transmitted between the electrical plug and the host connector.

16. An optical transceiver set on a host system, comprising:
an optical subassembly for converting a signal between an optical format and an electrical format;
a circuit board for mounting an electronic circuit communicating with the optical subassembly, the circuit board having an electrical plug to be mated with a host connector provided in the host system; and
a housing for installing the optical subassembly and the circuit board therein, the housing having a rear with a periodic structure, the electrical plug extending from the rear,
wherein the rear comes in contact with a host connector only in restricted portions corresponding to the periodic structure.

17. The optical transceiver of claim 16,
wherein the periodic structure is a plurality of hollows, the rear coming in contact with the host system only in portions except for the hollows.

18. The optical transceiver of claim 17,
wherein the hollow has a width shorter than a quarter wavelength of a signal transmitted through the electrical plug.

19. The optical transceiver of claim 16,
wherein the periodic structure is a plurality of projections, the rear coming in contact with the host system only in portions of the projections.

20. The optical transceiver of claim 19,
wherein the projections have a pitch to nearest neighbors shorter than a quarter wavelength of a signal transmitted through the electrical plug.
